(19) United States
(12) Patent Application Publication
(10) Pub. No.: US 2002/0138302 A1
(43) Pub. Date: Sep. 26, 2002

(54) Prepaid telecommunication card for health care compliance

(76) Inventor: David Bodnick, New York, NY (US)

Correspondence Address: BROWN, RAYSMAN, MILLSTEIN, FELDER & STEINER LLP, 900 THIRD AVENUE, NEW YORK, NY, 10022, US

(21) Appl. No.: 09/814,461

(22) Filed: Mar. 21, 2001

(51) Int. Cl. G06F 17/60; H04M 11/00

(52) U.S. Cl. 705/2; 379/90.01

(57) ABSTRACT

A prepaid telecommunication access card provides automated reminder messages via telephone to encourage patient compliance with health care programs, such as maintaining a regular program of prescription medication consumption. The card may have an identifier printed on it that enables the patient to a dial a reminder system and activate a given level of service, such as reminders for one month. The reminder system provides an authorization for the given level of services, and provides a reminder schedule based on information that is input by the patient or a third party.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

The present invention relates to the field of patient health care compliance. More particularly, the invention is a prepaid telecommunication access card that provides one or more reminder messages to encourage patient compliance with health care programs, such as maintaining a regular program of prescription medication consumption. In one embodiment of the invention, a prepaid telecommunication access card activates a reminder system that contacts the patient each time a dose of medicine should be taken.

In the United States, only one in three persons properly complete medication programs as prescribed by a doctor. The consequences of such noncompliance with medical prescriptions in the U.S. alone are estimated to include over 31 billion dollars in extra health care costs, 100 billion dollars in lost income, and over 125,000 deaths per year. Taking medicines at the correct times and dates may also significantly improve the efficacy of a course of treatment. Furthermore, the failure to adequately complete health care programs may lead to sickness of others, or can promote the development of drug resistant pathogens. Additionally, there is an economic loss, for patients, pharmacies, and pharmaceutical companies, due to unconsumed medicines. Of course, most patients want to follow their prescribed course of treatment, but even the most intelligent or diligent people may forget to take their medicine, and may skip one or more prescribed doses.

Medical compliance systems known to the inventor include interactive voice response (IVR) systems, medical notification systems, and integrated compliance devices. A variety of prepaid telecommunications access systems are also known to the inventor. These systems are described hereinbelow, however, none of these systems provide the inventive features of the present invention such as combining a prepaid telecommunication access card with an automated medical reminder system.

Known to the inventor are several interactive voice response (IVR) systems for medical compliance and notification purposes. U.S. Pat. No. 6,014,626, entitled Patient Monitoring System Including Speech Recognition Capability, and U.S. Pat. No. 5,722,418, entitled Method for Mediating Social and Behavioral Processes in Medicine and Business Through an Interactive Telecommunication Guidance System, use IVR systems with patient dialogs to encourage and monitor medical compliance. While these systems are used for medical compliance, none of these systems includes use of a prepaid telecommunication access card.

Also known to the Inventor are medical notification systems that transmit compliance reminders in a variety of formats. For example, the E-PILL PAGER MEDICAL REMINDER SERVICE sends a text message to a beeper or digital (text-enabled) cell phone reminding the user to take his or her medicine, along with optional instructions (see: http://www.medtimer.com/epill/seneptovourp.html). MEDIMOM sends text messages to a pager, digital cellular phone, email account or PDA, and includes a Web interface for setting up the messages (see: http://www.medimom.com/). The ARSDIGITA REMINDME SERVICE sends email reminders for any recurring events (see: http://remindme.arsdigita.com/). The HEALTHWATCH 100 MEDICAL REMINDER WATCH provides an enhanced digital watch, programmed through a computer interface, which can provides medical reminders and then records medication times (see: http://www.medtimer.com/epill/healthwatch.html). The VERIZON system for REMINDER MESSAGES FROM VOICE MAIL is used to program a voice mail system to call at a certain day and time to play back a previously recorded message (see: http://www.gte.com/CustomerSupport/HowDoI/UserGuides/rvmremind.html). The CALLING CALENDAR by SPERRY SOFTWARE uses a computer to place phone calls with appointment reminders (see: http://www.sperrysoftware.com/). MEDREMINDER INC. provides a pager and sends text reminder messages to it for a monthly fee (see: http://www.oregonlive.com/technw/99/09/tn091307.html). None of these systems, however, includes features of the present invention such as a prepaid telecommunication access card. And, the ease-of-use and marketability of such existing medical reminder systems may be significantly enhanced through use of the present invention.

Medical compliance devices that include integrated medicine delivery and compliance reminders are also known to the inventor. U.S. Pat. No. 5,597,072, entitled Totally Interactive Patient Compliance Method, describes a medicine delivery system with integrated compliance monitoring. MED-COMPANION, available from PIONEER MEDICAL SYSTEMS, INC, is a medical compliance machine that includes automated drug dispensing. The present invention is distinguished here, e.g., because it does not require any specific medication dispensing technology and adds the prepaid telecommunication access card.

Finally, U.S. Pat. No. 5,867,495, entitled System, Method and Article of Manufacture for Communications Utilizing Calling Plans in a Hybrid Network, teaches the use of prepaid telecommunication access cards for a variety of network services, such as web access. Here, the use of a prepaid telecommunication access card for medical compliance reminders is not disclosed.

Despite the variety of medical compliance devices noted above, patient medical compliance remains a problem. This is partly because existing medical compliance systems are unfamiliar to patients, are difficult to use, do not use conveniently available infrastructure (such as the phone system), and lack easy configuration facilities. Furthermore, existing systems are also difficult to market, promote, distribute, activate, use, and renew.

The present system and method addresses the above noted issues by providing a simple and intuitive way to deliver the reminder message by flexibly intercombining a prepaid telecommunication access card with medical compliance technologies. The card may be conveniently purchased at prescription counters or otherwise delivered with prescribed drugs, over-the-counter medicines, vitamins, health supplements, exercise regimens, or other treatment programs. Thus, the present invention provides a familiar, convenient and easy-to-use system and method for encouraging patient health care compliance, which may be effectively marketed by pharmacists, medical professionals or pharmaceutical companies.

### SUMMARY OF THE INVENTION

It is an object of the present invention to encourage compliance with health care programs.

It is another object of the present invention to remind a person to take their medicine as prescribed by a health care professional or other person.

It is another object of the present invention to provide a simple, convenient reminder encouraging a person to comply with their health care program.

The present invention is a system and method for use of a prepaid telecommunication access card for receiving one or more reminders to encourage compliance with health care programs, such as maintaining a regular program of prescription medication consumption. In one embodiment of the present invention, the prepaid telecommunication access card is a physical card that is offered to the patient at a point-of-sale (POS) location, such as the check out counter of a pharmacy. Once activated by the card, a reminder system contacts the patient each time a dose of medicine should be taken. The patient may select a variety of preferences, such as: call times and dates; message content; call forwarding number(s); and, whether a response is expected from the patient.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a flow chart of a process for using a prepaid telecommunication access card for health care compliance in accord with an embodiment of the present invention.

FIG. 2 is block diagram of a system for using a prepaid telecommunication access card for health care compliance in accord with an embodiment of the present invention.

FIG. 3 illustrates a health care compliance reminder system in accord with an embodiment of the present invention.

### DETAILED DESCRIPTION OF THE PREFERRED EMBODIMENTS

Embodiments of the present invention will now be described in detail with reference to the accompanying figures.

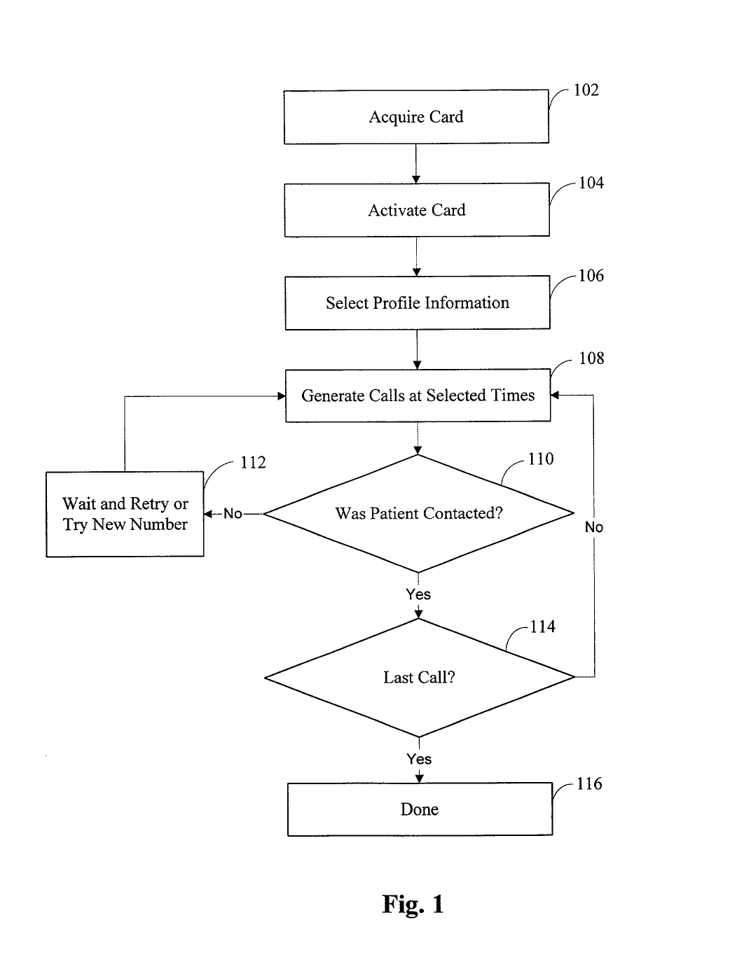

FIG. 1 is a flow chart of a process for using a prepaid telecommunication access card in accord with an embodiment of the present invention. In step 102, the card is acquired by a patient, either at a point-of-sale (POS) location or through a third party such as a pharmacy, doctor, hospital, or drug company. In step 104, the card is activated by an initial call placed by the patient, or by a call placed by third party such as a pharmacist. Once the card is active, a variety of patient reminder profile preferences, such as the patient's name and contact numbers, are configured in step 106. The medical compliance reminder system is now ready to transmit a medical compliance reminder at the next dosage time, step 108. When a reminder message is transmitted, the system will determine if the transmission was successful, step 110. If the transmission was not successful then the system will wait and retry the call or try other contacts, step 112. The system tests if there are further calls to be made in step 114. If there are further reminder calls, then the system returns to step 108 to generate additional calls at selected times, otherwise the system terminates in step 116.

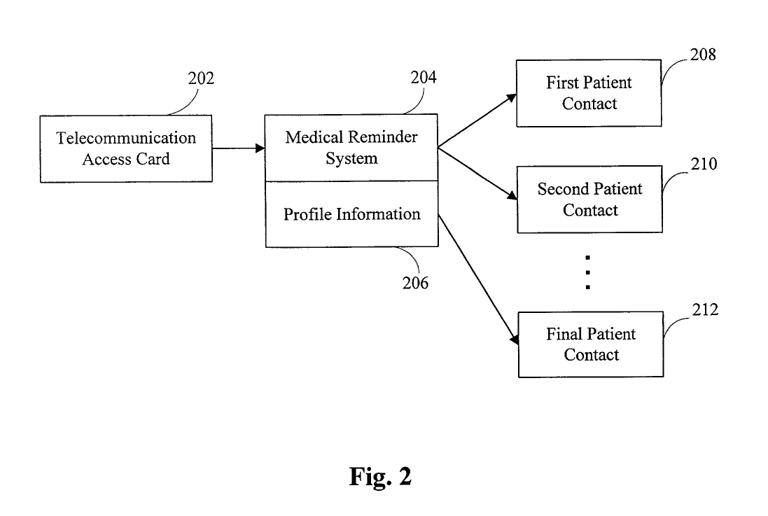

FIG. 2 is block diagram of a system for using a prepaid telecommunication access card in accord with an embodiment of the present invention. Here, a telecommunications access card 202 is used to activate a medical reminder system 204. The medical reminder system 204 has access to patient profile information 206, such as the patient's name and telephone contact numbers. Once the medical reminder system is activated, a series or patient contact calls 208, 210, 212 are made to transmit medical compliance reminders to the patient.

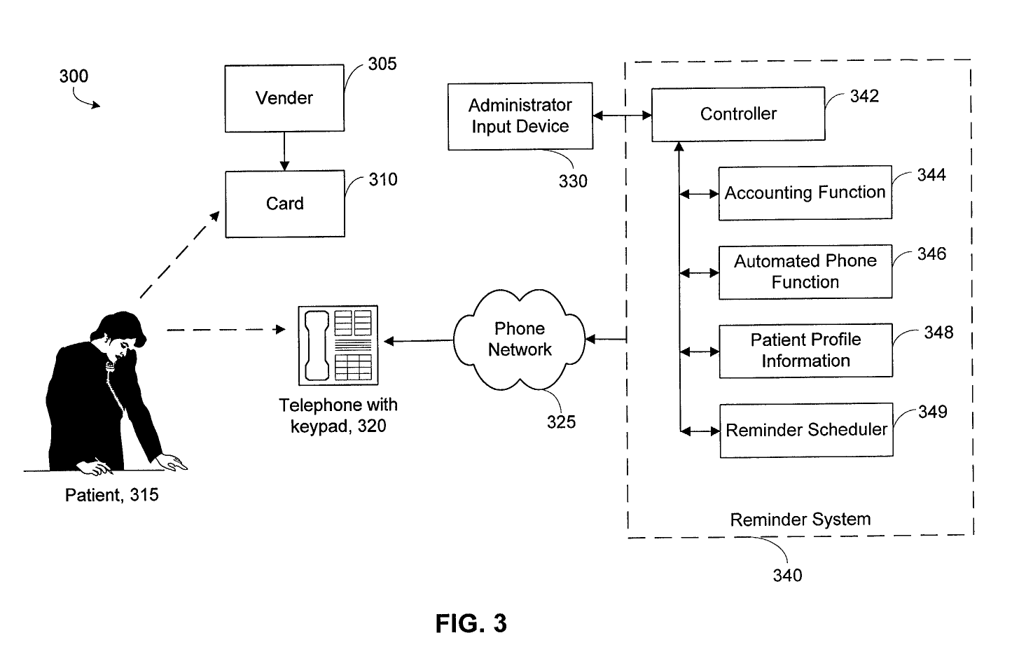

FIG. 3 illustrates a health care compliance reminder system in accord with an embodiment of the present invention. The system shown generally at 300 includes a vendor 305 who sells a pre-paid card 310 to a patient 315. The card includes a PIN or other authorization code, and a phone number. Using a conventional telephone 320, the patient 315 dials the phone number to connect, via a phone network 325, with a reminder system 340. The phone 320 may include a keypad. The reminder system includes a controller 342, which communicates with an accounting function 344, an automated phone function 346, a patient profile information database 348, and a reminder scheduler 349. These components may be provided using computer hardware and software technologies which should be apparent to those skilled in the art.

An administrator input device 330, such as a keyboard, allows an administrator to enter information regarding the patient, such as a patient profile which is stored at the database 348, prior to the patient accessing the reminder system 340. The patient profile may include information regarding what medicines the patient should be taking. Moreover, the reminder scheduler 349 may be programmed with an associated schedule based on the patient profile (e.g., the patient should be reminded to take one pill of a first medicine once a day, one pill of a second medicine every other day, and so forth). The automated phone function 346 dials the patient at the appropriate time to provide an automated voice reminder.

The accounting function 344 keeps track of the remaining amount of reminders that are to be provided to the patient based on the value of the pre-paid card 310. For example the card 310 may provide one month of reminders. When the patient phones the reminder system 340, a prompt is presented by the automated phone function 346 to enter the PIN or other identifier on the face of the card 310, e.g., using the keypad. The accounting function 344 is then provided with the PIN, e.g., via the controller 342, and it is cross-checked against a list of valid PIN numbers. A level of reminder service is also associated with each PIN, e.g., one moth, two months, etc.

The patient may be further prompted to enter an identifier, such as a social security number. This identifier is used to access the patient profile information that has already been established on behalf of the patient by the administrator. Or, the PIN may be sufficient to identify the patient, assuming the PIN information is recorded prior to its sale to the patient. Having the patient enter an identifier allows the cards to be sold to a general population of patients.

The appropriate reminder schedule can then be activated so that the appropriate reminders are received at the scheduled times for the specific patient's medicines. Note that other reminder may also be provided. For example, a diabetic patient may be reminded to take a blood sugar test. Reminders of upcoming doctor's appointments and the like can also be provided. Alternatively, the patient may enter reminder information himself via the telephone.

In general, the prepaid telecommunication card for health care compliance may provide a wide variety of benefits. As mentioned, first, the patient, or someone acting on their behalf, obtains the prepaid telecommunication access card and activates an account, with a corresponding account identifier, via a Personal Information Number (PIN). After activation, the patient connects to one or more reminder system servers via phone or computer network and configures the account, including callback number(s), reminder schedule, and other information that are stored in a patient profile database. Or, as discussed, some or all of the configuration may be made by a system administrator, health care provider or other third party. Later, at or near the designated time, the reminder system servers place a call to the patient with a medication compliance reminder. The reminder system may, optionally, make follow-up inquiries such as whether the patient took the medicine, has experienced side effects, wants to recharge the prepaid card, or wants to refill the prescription.

The telecommunication access card, also called a ‘phone card’ or referred to as a ‘Personal Information Number’ (PIN) herein, may be a physical card such as a plastic, paper, or other laminar or flat surface. For example, the card may be in the same format as a typical driver's license, credit card or other type of consumer card. The telecommunication access card may also take other various forms. For example, the prepaid telecommunication access card, phone card or PIN may also be printed or affixed onto the medication container, or printed in a communication such as a letter or postcard, thus eliminating the need for a laminar card. Alternately, the card may be delivered electronically via the Internet, an Intranet, email, a web page, a personal digital assistant (PDA), a handheld computing device, or may be stored or delivered through a smart card. Typically, the telecommunication access card includes a Personal Information Number (PIN), which may be any alphanumeric sequence, symbols, or other data. The PIN may be hidden, encoded or human readable. In one embodiment, a hidden or scratch-off PIN may be used on the card or packaging. Alternately, the PIN may be visible, but would require subsequent activation to prevent unauthorized use. An encoded PIN, such as a bar code or other information encoding, may be scanned or otherwise entered into a computer system and recognized by an automated process as known to one skilled in the art of computer image scanning and recognition. Thus, the terms ‘telecommunication access card’, ‘phone card’ and ‘PIN’ are synonymous herein and may also refer to a variety of objects that are not physical ‘cards’.

The term ‘patient’ is used herein to mean anyone acting on the patient's behalf, and the term ‘patient’ does not imply any specific type of doctor-patient relationship or ongoing medical treatment program. A ‘patient’, as used herein, means anyone who uses the prepaid telecommunication access card for medical compliance reminders, including a health care professional, caretaker, relative, friend, agency, administrator, computer service, or a representative acting on behalf of the patient.

The prepaid telecommunication access card may be activated at the point of purchase or at a later date. The card may be activated by the patient, by a representative of the vendor or manufacturer, by a sales agent such as a pharmacy clerk, or through an automated computer system. Activation may occur in the store, in the home, or at any arbitrary location, and may conducted over the phone, through the web, through an internal network, or through a portable or wireless device such as a PDA. In a preferred embodiment, the patient, pharmacist, doctor, nurse, caretaker or their representative accesses an interface that permits the activation of the card and configuration of the reminders. This interface may be through phone, web, proprietary computer network, touch tone, spoken, microphone, keyboard, or mouse selection interface. Some of this information entry may be automated based on data already present in the pharmacy's, doctor's or administrator's computer systems, or may be present from a previous session by the patient.

In a preferred embodiment of the present invention, the medical reminder system may be an automated call processing center, a computer-based telecommunication system, or an interactive voice response system as is known in the art of automated call generation and processing. For each patient, a set of patient profile information is stored in a database. The profile information may be entered by the patient, by a doctor, administrator or other third party. The medical reminder system accesses the patient profile database that stores patient data and other profile information including, without limitation, the names and contact numbers of patients who will receive medical reminders. The system also has a timing mechanism for placing calls at specified dates and times as specified in the patient profile database. In one embodiment of the present invention, the profile information may be modified through an interface implemented via a touch tone telephone, a Personal Digital Assistant (PDA), a freeform email message, an email template message, an interactive web page, or other interface means. Patient profile configuration information may also be summarized for easy confirmation. For example, patient profile information configuration may be summarized on an interactive web page, where it can be reviewed for accuracy and confirmed when correct.

Generally, the patient profile information may include any information about the patient. In the preferred embodiment, patient profile information includes: (1) the patient's name, with an optional recording of the patient or other person saying the name so the patient will be greeted with a familiar voice and with proper pronunciation; (2) the patient's contact phone numbers; (3) instructions to try a sequence of numbers or other contact devices until a response is provided indicating presence of the patient, or until a suitable answering machine/voicemail is reached; (4) instructions to specify different numbers or number sequences for different days of the week, times of day, special days such as holidays, or combinations thereof. There are several ways to customize the message itself including: (1) selecting a choice of language; and, (2) selecting a custom message left by patient, loved one, or selected from one or more preferred voices, for example those of famous people.

The reminder system may also be configured with the administrator's contact information, such as phone numbers; email addresses; fax numbers; preference regarding order to try; ability to specify different numbers or preferences for different days of the week, times of day, special days, or combinations thereof. The system may also set a parameter that determines whether to contact the administrator or third party when a patient cannot be reached, has discontinued the medication, has experienced side effects, needs a prescription refill, or needs to add more money to the prepaid reminder account.

In the configuration profiles for each medicine, parameters may include: (1) the days and times at which a reminder should be made (simplifying choices such as “every day”, or an interval of days may be presented); (2) the number of reminders to make (generally corresponding with the number of pills to take); (3) whether usage instructions should be read with some or all of the reminders, and, if so, the instructions to be read as to the use of the drug (e.g. recorded, typed or pre-typed); (4) whether an answering machine message should be left; (5) whether the system should ask for the patient before asking whether s/he has taken the medicine; (6) whether to wait for the patient to take the medicine before hanging up; (7) whether to remind the customer to order a refill when the medicine is running out; (8) whether the patient should be asked about specific side effects, and if so, how often; (9) whether only one reminder call needs to be made if two or more medicines can be taken simultaneously; and (10) an optional ringback at number(s) that patient provided, and/or email(s) and/or faxes, to confirm proper setup.

One embodiment of the present invention computes the patient's time zone based on the geographical location of the area code to phone, and optionally allows the patient to adjust the time zone if desired. Several reminder schedules may also be combined in embodiments of the invention. For example, if two medicines may be taken at the same time, the system will combine the two reminder messages into a single message that reminds the patient to take both medications.

The phone reminders are generally made within a fixed time period, e.g. within 15 minutes of the time specified by the user the system will phone the patient (or establish contact in the way the patient requested). If a person answers, an optional recorded or synthesized message asks the patient to come to the phone and press phone key responses such as a ‘1’ if the patient is available, or ‘2’ if the patient is not. If the user had been prompted to speak the patient's name during setup, the recording of this name can be spliced into the message at the point(s) that the name should be read. If an answering machine picks up and the user has specified that other contact numbers should be tried, or if nobody picks up, or if the person who picks up indicates that the patient is not there, then the system will try the next contact method if there is one.

If the patient cannot be reached, depending on user preferences, the medical reminder system may call alternate contact number(s) to leave an answering machine message, and may also wait a preset interval, such as half an hour, and try again. The system may, optionally, give up after a number of unsuccessful attempts, or may also contact the system administrator or other contact, such as a doctor or relative, to notify them that the patient could not be reached. The system may optionally contact a third party when the patient is unreachable for a several days, dosage intervals, contact attempts, or if someone answers and indicates that the patient cannot come to the phone.

Once the patient has been contacted, the medical reminder system will play a reminder message that asks whether they have taken their medicine, or simply plays a reminder to take the medicine. The term ‘reminder’ or ‘medical reminder’ includes, but is not limited to any voice, text or graphical message delivered through the telephone system, the Internet, or any wireless device. For example a medical reminder may include a prerecorded telephone call or an email message. In other embodiments of the present invention, the medical reminder system may activate a beeper or generate text for electronic messages such as electronic mail messages, Simple Message System (SMS) messages, or other message formats.

The content of the reminder message may vary according to the medical situation or patient preferences. The system may either use complete prerecorded messages or may splice together custom messages using techniques known to those skilled in automated call processing and telemarketing. For example, the name of the medicine can be played from a recording or with text-to-speech synthesis of the medicine name, or with a pre-stored recording that corresponds with the names of a number of common medicines and spliced into a general message to take a medicine.

Specific interaction scenarios may also be incorporated into the medical reminder system. In one embodiment of the invention, the system will prompt the patient to press ‘1’ if they have taken their medicine; ‘2’ if they want to be reminded again in half an hour; ‘3’ if they want to be reminded again at a different time; ‘4’ if they have concerns about taking the medicine; or, ‘5’ if they have discontinued the use of the medicine for any reason. If the patient indicates that they have taken their medicine, the system may optionally thank or congratulate them, and record this successful transaction to a database.

In one embodiment of the present invention, the system inquires about the patient's status, for example by asking the question ‘Are you ok?’. The patient may respond by pressing a key, for example pressing ‘1’ if they are ok and pressing any other key if they are not ok. Alternately, the patient may provide a verbal response. In general, the system will infer that the patient is not ok, if there is no response. The patient or an administrator may configure the system to initiate a variety of responses, if the patient indicates that they are not ok. Responses may include scheduling a follow-up call, contacting a third party, contacting a doctor or health care provider, or requesting emergency services.

If the patient indicates that s/he wants to be reminded again after an unspecified interval, the system will ask for input regarding when to try back or whether the patient wants to be reminded again at a pre-specified or just-specified interval. Based on the selected response, the systems will mark the deferred transaction to the patient profile database and repeat the process at the specified time If the patient has concerns about taking the medicine, the system can ask if s/he would like to hear a list of potential side effects. If this option is selected, the system will play a list, optionally categorized by severity and in conjunction with instructions about discontinuation or other instructions for that severity category, and ask the patient if they believe they may have one or more symptoms. If the patient indicates affirmatively then the system advises the patient to discontinue use immediately (if appropriate); to contact their physician or pharmacist immediately for further instructions (if appropriate); and/or to contact a poison control center or other entity immediately for further instructions (if appropriate). Optionally, if the condition is severe, the system may automatically bridge the call, or offer to bridge the call, to connect the patient to a poison control center, emergency center, doctor or other entity, and pass selected patient profile information to that entity, such as the patient's name, condition, phone number, possible side effects, medicine and other medicines that are being taken, location (which if not already stored may be computed from the phone number and/or a reverse telephone directory lookup). Optionally, depending on the administrator's configuration, the system may contact the administrator or another contact (such as the doctor's office) to alert that contact to the potential side effect.

In one embodiment of the present invention, the system will ask if the patient would like to discontinue the reminder calls, or if the patient would like another call after specified time interval to ask whether to discontinue the reminder phone calls. For example, calls can be ‘turned off’ for a period of time, such as during a vacation. If the patient wants more time to determine whether to discontinue, the system may ask for the time interval if necessary, phone back at that time to present the discontinuation question again, optionally asking whether more time is needed to make that decision. If the patient affirmatively wants to discontinue use of the reminder system, then the system registers that preference to the database and cancels future reminders for this medicine. Optionally, if configured as such by the administrator, the system will contact the administrator or other concerned party to report this event. If the patient has discontinued use of the medicine, the system can provide a message that conveys the danger of not completing a prescription course unless on the advice of a doctor, suggesting that they contact a doctor to discuss their concerns. The system then registers this information to the patient profile database and cancels future reminders for this medicine. Optionally, if configured as such by the administrator, the system can contact the administrator or concerned party to report this event. The system can also inquire whether the patient would like time to discuss this with their doctor and whether the patient wants to receive a callback within a couple hours or at a different time to confirm that they have chosen to discontinue use of the medicine. If affirmative, then the system records the time interval for the callback, if necessary, and records this transaction to the database to schedule the callback. The system may also permit the bridging of the call to a doctor or health care practitioner.

When the card is close to expiration or when the card has expired, the system gives the user a choice to add more money to the card, if the prepaid reminders are running out. Money may be added either: (1) with a credit card already on file; (2) with a new credit card; or, (3) billed to a third party, if such an arrangement already exists. When a additional calls are added to the card, the patient may elect to keep selected profile information. In an emergency situation, an expired card may still be used to access services as appropriate.

The system may optionally offer a refill message if a refillable prescription is about to expire, or, optionally, offer to connect the patient directly to a pharmacy to refill the prescription (possibly the same pharmacy where they bought the reminder card and, presumably, the prescription). Alternatively, the system may request that the pharmacy automatically refill the prescription. This may be done without bridging the call. The system may optionally offer a health tip, with the option for the patient to learn more by pressing a key. The system, optionally, may offer a sponsor message, with the option to learn more or take some action by pressing a key. Such optional messages are only played if an emergency situation has not arisen.

When a session is complete the system will typically say goodbye and disconnect, if the call has not been bridged.

At any time during the life of the prepaid telecommunication access card a summary report may be created that describes the patient's actual medical compliance history. For example, the report may summarize prescribed dates and times for taking medication doses in conjunction with the patient's replies indicating whether they have complied with the prescribed dosage dates and times. Other information, such as side effects questions may be included in the summary report. The report may be electronic or printed and may be delivered through email, a web page or other document format. The report may be delivered to the patient, a doctor or other designate of the patient.

Additional optional features of the present invention include: (1) checking harmful drug interactions and providing appropriate warnings, for example if incompatible drugs are entered; (2) when medicine is running low, offer a reminder to refill the prescription with an choice to be connected directly to the pharmacy or to have the prescription refilled directly; (3) offer to ‘auto-refill’ the card when the card runs out of reminders by automatically adding a certain amount to the card and billing the added amount to a credit card.

There are several, optional, commercial alternatives for financing the prepaid telecommunication access card. Cards may be paid for (in part or in full) by a sponsor who wishes to play a prerecorded message. Cards may be paid for by sponsor with a message, in which the user can press a key or keys to receive information. Cards may be paid for (in part or in full) by medical insurance, or a medical insurance company to improve compliance. Cards may be paid for by companies, such as pharmacies or drug manufacturers, which place a message reminding the patient to refill their prescription. This may also include the option to connect directly to the pharmacy at which the prepaid reminders were purchased, or at the sponsoring pharmacy of choice, with an optional promotional fee paid by the pharmacy.

There are also several options for billing for reminders through use of the prepaid telecommunication access card. Cards may charge per reminder, for example 30 prepaid phone reminders. Cards may charge per interval, possibly with limits such as the geographic area of the reminder calls and the maximum number of reminder phone calls, for example unlimited reminder calls for one month in the New York City calling area. And, cards may charge per prescription, for example, all the necessary phone reminders for a particular prescription. Additionally, cards may be purchased as gifts, or as a part of a ‘get well’ card or package.

The prepaid telecommunication access card can be marketed in a variety of ways. As discussed above, the card may be sold at the point-of-sale counter in a pharmacy or store. The card may also be directly marketed to consumers through broadcast, print or other media. The card may be sold through electronic media, such as the World Wide Web. The card may be sold through doctor's offices, and may be recommended or prescribed by doctors. The card may be sold through pharmaceutical companies or pharmacies, and may be bundled with or otherwise provided with prescription orders. In certain sales scenarios, the card is paid for by a pharmacy, pharmaceutical company, insurance company, insurance policy benefits, or other third party and may be provided for free or at a discount to the end-user patient, doctor or downstream distributor.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

I claim:

1. A telecommunication system for transmitting medical compliance reminders, the telecommunication system comprising:
a prepaid telecommunication access card;
a patient reminder profile that is activated by the prepaid telecommunication access card; and,
a medical compliance reminder system that transmits a plurality of medical compliance reminders to the patient in accordance with the patient reminder profile; whereby a patient obtains the prepaid telecommunication card and receives a plurality of medical compliance reminders that are transmitted by the medical compliance reminder system using the patient reminder profile.

2. The system of claim 1, wherein the patient reminder profile further comprises:
the patient's name; and,
the patient's contact information.

3. The system of claim 1, wherein the patient reminder profile further comprises a number of medical compliance reminders to make.

4. The system of claim 1, wherein the patient reminder profile further comprises a sequence of dates and times corresponding to each medical compliance reminder.

5. The system of claim 1, wherein one reminder transmission combines reminders for multiple medicines if the multiple medicines can be taken simultaneously.

6. The system of claim 1, further comprising an interface for configuration of the patient reminder profile.

7. The system of claim 6, where the interface for configuration of the patient reminder profile is an interactive World Wide Web form.

8. The system of claim 6, where the interface for configuration of the patient reminder profile is an interactive touch tone telephone system interface.

9. The system of claim 6, where the interface for configuration of the patient reminder profile is an interactive voice response system.

10. The system of claim 1, further comprising confirmation of patient reminder profile configuration information.

11. The system of claim 1, wherein the patient reminder profile comprises at least one of:
a language selection;
a list of at least one patient contact points;
a list of at least one patient contact telephone numbers;
a sequence of patient contacts to try until a response is received indicating the presence of the patient;
a sequence of patient contacts to try until an answering machine is obtained;
a selection indicating whether an answering machine message should be left;
at least one alternate patient contact sequence for time periods;
at least one different reminder preference for different time periods;
at least one custom message left by the patient;
at least one custom message left by a third party, such as a loved one;
at least one custom message selected from a list of prerecorded voices;
an option indicating whether usage instructions should be included with the reminders;
a set of instructions to be included as to the use of the medicine;
a set of instructions to be included as to how the patient should handle missed doses;
a selection indicating whether the system should ask for the patient before reminding the patient whether they have taken the medicine;
a selection indicating whether to wait for the patient to take the medicine before hanging up;
a selection indicating whether to remind the patient to order a refill when the medicine is running low;
a selection indicating whether the patient should be asked about specific side effects, and if so, how often;
a selection indicating whether to contact an administrator in situations when a patient cannot be reached;
a selection indicating whether to contact an administrator in situations when a patient has discontinued the medication;
a selection indicating whether to contact an administrator in situations when a patient needs a prescription refill; and,
a selection indicating whether to contact an administrator in situations when a patient needs to add more money to the prepaid telecommunication access card.

12. The system of claim 1, wherein the administrator profile comprises at least one of:
at least one administrator phone number;
at least one administrator beeper contact number;
at least one administrator personal digital assistant (PDA) contact address;
at least one administrator instant message account;
at least one administrator email address; and,
at least one administrator fax number.

13. The system of claim 1, further comprising a report summarizing patient reminders and responses.

14. A method for using a prepaid telecommunication access card to transmit at least one medidcal compliance reminders, the method comprising the steps of:
obtaining a prepaid telecommunication access card;
activating a medical compliance reminder system with the prepaid telecommunication access card;
storing patient profile information accessible to the medical compliance reminder system; and,
transmitting a plurality of medical compliance reminder messages using the patient profile information;
whereby a patient obtains the prepaid telecommunication access card, activates the medical compliance reminder system with the prepaid telecommunication access card, stores patient profile information accessible to the medical compliance reminder system, and initiates the medical compliance reminder system to transmit a plurality of reminder messages to the patient using the patient profile information.

15. The method of claim 14, further comprising the steps of:
asking whether the patient took the medicine; and,
obtaining a patient acknowledgement response to the medical reminder message.

16. The method of claim 14, further comprising the steps of:
obtaining the patient's name;
obtaining patient contact information; and,
storing the patient's name and contact information.

17. The method of claim 14, further comprising the step of configuring patient profile information to include a number of medical compliance reminders to transmit.

18. The method of claim 14, further comprising the step of configuring the patient profile information to include a sequence of dates and times for each medical compliance reminder.

19. The method of claim 14, further comprising the step of combining multiple message transmissions for multiple medicines so that one reminder message is transmitted if two or more medicines can be taken simultaneously.

20. The method of claim 14, further comprising at least one of the steps of:
obtaining a language selection;
obtaining a sequence of patient contacts to try until a response is received indicating the presence of the patient;
obtaining a sequence of patient contacts to try until a response is received indicating an answering machine;
obtaining a list of at least one patient contact point;
obtaining at least one alternate patient contact sequence for different days of the week, times of day, special days, and combinations thereof;
obtaining at least one different patient profile preference for different days of the week, times of day; special days, and combinations thereof;
obtaining at least one custom message from the patient;
obtaining at least one custom message from a third party, such as a loved one;
selecting at least one custom message from a list of prerecorded voices;
obtaining selection information indicating whether usage instructions should be transmitted with some or all of the reminders;
obtaining selection information indicating instructions to be transmitted as to the use of the medicine;
obtaining selection information indicating instructions to be read as to how the patient should handle missed doses;
obtaining selection information indicating whether an answering machine message should be left;
obtaining a selection indicating whether the system should ask for the patient before asking whether they have taken the medicine;
obtaining a selection indicating whether to wait for the patient to take the medicine before hanging up;
obtaining a selection indicating whether to remind the customer to order a refill when the medicine is running out;
obtaining a selection indicating whether the patient should be asked about specific side effects; and,
obtaining a selection indicating whether to contact an administrator in situations when a patient cannot be reached;
obtaining a selection indicating whether to contact an administrator in situations when a patient has discontinued the medication;
obtaining a selection indicating whether to contact an administrator in situations when a patient needs a prescription refill; and,
obtaining a selection indicating whether to contact an administrator in situations when a patient needs to add more money to the prepaid reminder account.

21. The method of claim 14, further comprising generating and transmitting confirmation of patient reminder profile configuration information.

22. The method of claim 14, further comprising at least one of the steps of:
obtaining at least one administrator phone number;
obtaining at least one administrator beeper contact number;
obtaining at least one administrator PDA contact address;
obtaining at least one administrator Instant Message account;
obtaining at least one administrator email address; and,
obtaining at least one administrator fax number.

23. The method of claim 14, further comprising the step of generating a report summarizing patient reminders and responses.

24. The method of claim 14, further comprising interaction scenarios comprising at least one of the steps of:
leaving a message if the patient cannot be reached;
generating a message that asks the patient to press a specified key at the phone;
generating a message that asks the patient to come to the phone and say a specified phrase;
generating a message that asks the patient to come to the phone and press a specified key, and if the patient is not there asking the person who answers to press a key;
generating a message that asks the patient to come to the phone and say a specified phrase, and if the patient is not there asking the person who answers to say a specified phrase;
splicing a recording of the patients name the message at the points where the name should be read;
trying the next patient contact number if an answering machine picks up and the patient has specified that other contact methods should be tried;
trying the next contact method if the person who responds indicates that the patient is not there;
waiting a preset interval and then trying again, and giving up after a number of unsuccessful attempts;
contacting the administrator, doctor, relative, or other third party to notify them that the patient could not be reached; and,
contacting an administrator, doctor, relative, or other third party if the patient is unreachable for a few consecutive reminders;

25. The method of claim 14, further comprising the step of playing a name of the patient's medicine from at least one of: (a) a recording that an administrator had made with text-to-speech of the medicine name, and (b) a pre-recorded message that corresponds with the medicine name, where the pre-recorded message is selected from a plurality of pre-recorded messages for a number of common medicines

26. The method of claim 14, further comprising the steps of:
prompting to the patient to press a first key on the telephone when their medicine has been taken;
prompting to the patient to press a second key on the telephone if to be reminded again after a predetermined time;
prompting to the patient to press a third key on the telephone if to be reminded again at a different time;
prompting to the patient to press a fourth key on the telephone if there are concerns about taking the medicine; or,
prompting to the patient to press a fifth key on the telephone if they have discontinued the use of the medicine;
transmitting a congratulatory message if the patient indicates the medicine has been taken; and,
recording the transaction to a database.

27. The method of claim 14, further comprising a user interaction scenario comprising:
asking if the patient wants to be reminded again in an unspecified interval; and,
asking for input regarding when to try back, marking a deferred transaction in response thereto to a database, and repeating the reminder at the specified time.

28. The method of claim 14, further comprising the steps of asking questions if the patient has concerns about taking the medicine, the questions comprising:
asking if the patient would like to hear a list of potential side effects, if so, transmitting a list of the potential side effects and possible remedies therefor;
asking if the patient believes they may have at least one symptoms, if so, advising the patient to take at least one of the following actions:
discontinuing use of the medicine immediately;
contacting a physician or pharmacist immediately for further instructions;
contacting a poison control center, hospital, emergency center, or doctor for further instructions; and,
bridging the call directly to a poison control center, hospital, emergency center, or doctor, with a subset of the patient profile information.

29. The method of claim 28, further comprising the step of contacting an administrator, pharmacy, pharmaceutical company, or doctor to alert them to a potential side effect.

30. The method of claim 14, further comprising at least one of the steps of:
asking if the patient would like to discontinue the reminder phone calls;
asking if the patient would like another call after a specified time interval;
contacting the patient after a specified time interval to ask whether to discontinue the reminder phone calls;
asking whether to continue the reminders;
asking if the patient wants more time to determine whether to discontinue the calls;
asking for the time interval;
calling back at a specified time to present the discontinuation question again, and
asking whether more time is needed to make that decision;
asking if the patient wants to discontinue use and registering an affirmative response to the database to cancel future reminders for this medicine;
asking if the patient wants to discontinue use and registering an affirmative response to the database to cancel future reminders for this medicine, and contacting the administrator to report this event;
transmitting a message if the patient has discontinued use of the medicine conveying the danger of not completing a prescription course unless on the advice of a doctor and suggesting that the patient contact a doctor, registering the transaction to a database, and canceling future reminders for this medicine;
transmitting a message if the patient has discontinued use of the medicine conveying the danger of not completing a prescription course unless on the advice of a doctor and suggesting that the patient contact a doctor, registering the transaction to a database, and canceling future reminders for this medicine, and contacting the administrator to report this event;
asking whether the patient would like to discuss their decision with a doctor;
asking whether the patient would like the call to be bridged to a doctor;
asking whether the patient wants to receive a callback at a different time to confirm that they have chosen to discontinue use of the medicine, and if affirmative, recording the time interval for the callback; and,
recording this transaction to the patient profile information database and scheduling the deferred reminder.

31. The method of claim 14, where the prepaid telecommunication access card is activated by at least one of the steps of:
activating the card in the store;
activating the card on the web;
activating the card over the phone;
activating the card through a personal digital assistant;
activating the card through a handheld computing device;
activating the card by a representative of the vendor;
activating the card by a manufacturer;
activating the card by a patient;
activating the card by a computer or automated system; and,
activating the card by a health care professional or aide.

32. The method of claim 14, further comprising a user option to add more reminders to the card, the method comprising at least one of the steps of:
charging the new reminders to a payment method already on file;
charging the new reminders to a new payment method;
transferring money from an account;
billing to the patient; and, billing to a third party.

33. The method of claim 14, further comprising at least one of the steps of:
transmitting a refill message if a refillable prescription is about to expire;
offering to connect the patient directly to a pharmacy to refill a prescription if a refillable prescription is about to expire; and,
requesting the pharmacy to automatically refill the prescription if a refillable prescription is about to expire.

34. The method of claim 14, further comprising the step of offering a health tip, with an option to learn more by pressing a key on a phone.

35. The method of claim 14, further comprising the step of transmitting a sponsorship message, with an option to learn more by pressing a key on a phone.

36. The method of claim 14, further comprising the steps of:
checking for harmful drug interactions; and,
sending a warning to the patient if a potentially harmful drug interaction is detected.

37. The method of claim 14, further comprising an auto-refill option that automatically adds additional reminders to the card when the card runs out of reminders.

38. The method of claim 14, further comprising at least one of the steps of:
obtaining at least a partial payment from a sponsor who has prerecorded a message;
obtaining at least a partial payment from a sponsor who has a prerecorded message in which the user can press a key or keys to hear more information from the sponsor;
obtaining at least a partial payment from medical insurance;
obtaining at least a partial payment from a medical insurance company;
providing a message reminding the person to refill their prescription;
providing a message reminding the person to refill their prescription and connecting the patient directly to the pharmacy at which the prepaid reminders were purchased;
providing a message reminding the person to refill their prescription and connecting the patient to the sponsoring pharmacy;
providing a message reminding the person to refill their prescription, and connecting the patient to the sponsoring pharmacy with a promotional fee paid by the pharmacy;
charging per reminder;
charging per minute; and,
charging per prescription.

39. The method of claim 14, further comprising commercial alternatives for marketing the prepaid telecommunications access card comprising at least one of the steps of:
marketing the prepaid telecommunication card to a pharmacy;
marketing the prepaid telecommunication card to a doctor;
marketing the prepaid telecommunication card to a doctor who recommends use of the card to a patient;
marketing the prepaid telecommunication card to a health care professional;
marketing the prepaid telecommunication card to a pharmaceutical distributor; and
marketing the prepaid telecommunication card to a pharmaceutical company.

40. The method of claim 14, further comprising a method of identifying the patient comprising at least one of the steps of:
requesting a security confirmation to verify whether the person who picks up the phone is actually the patient by asking for a secret piece of information; and,
requesting a security confirmation to verify whether the person who picks up the phone is actually the patient, by analyzing the patient's voice.

41. The system of claim 14, wherein the step of transmitting the medical reminder message includes the step of transmitting a query message that inquires if the patient is ok.

42. A medical reminder system comprising prepaid personal information number (PIN) that activates a medical compliance reminder system.

43. A prepaid telecommunication access card, comprising:
a laminar card; and,
a prepaid personal information number (PIN) that activates a medical compliance reminder system.

44. The system of claim 43, wherein the prepaid personal information number (PIN) is hidden under a scratch-off coating.

45. A medicine container comprised of:
a container; and,
a prepaid personal information number (PIN) that activates a medical compliance reminder system.

46. A patient medical compliance reminder system, comprising:
a prepaid telecommunication access card having an identifier printed thereon;
a medical compliance reminder system having an automated telephone function, an accounting function, and a patient profile/reminder function;
wherein the automated telephone function is adapted to receive the card identifier via a telephone call placed thereto by the patient;
the accounting function is responsive to the card identifier received by the automated telephone function for activating an authorization of a corresponding level of medical reminder services;
the patient profile/reminder function provides a schedule for the medical reminder services; and
the automated telephone function is responsive to the schedule for providing automated reminders to the patient via telephone while the authorization is activated.

47. The system of claim 46, wherein:
the patient profile reminder function provides the schedule based on information provided by the patient to the automated telephone function via the telephone call.

48. The system of claim 46, wherein:
the patient profile/reminder function provides the schedule based on information provided by an administrator of the medical compliance reminder system.
